(19) United States
(12) Patent Application Publication
(10) Pub. No.: US 2008/0077387 A1
(43) Pub. Date: Mar. 27, 2008

(54) MACHINE TRANSLATION APPARATUS, METHOD, AND COMPUTER PROGRAM PRODUCT

(75) Inventor: Masahide Ariu, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/686,640

(22) Filed: Mar. 15, 2007

(30) Foreign Application Priority Data
Sep. 25, 2006 (JP) 2006-259297

(51) Int. Cl. G06F 17/28

(52) U.S. Cl. 704/3

(57) ABSTRACT

A machine translation apparatus includes a receiving unit that receives an input of a plurality of speeches; a detecting unit that detects a speaker of a speech from among the speeches; a recognition unit that performs speech recognition on the speeches; a translating unit that translates a recognition result to a translated sentence; an output unit that outputs the translated sentence in speech; and an output control unit that controls output of speech by referring to processing stages from receiving to outputting a first speech that is input first from among a plurality of the speeches, a speaker detected with respect to the first speech, and a speaker detected with respect to a second speech that is input after the first speech from among a plurality of the speeches.

### CROSS-REFERENCE TO RELATED APPLICATIONS

This application is based upon and claims the benefit of priority from the prior Japanese Patent Application No. 2006-259297, filed on Sep. 25, 2006; the entire contents of which are incorporated herein by reference.

### BACKGROUND OF THE INVENTION

1. Field of the Invention

The present invention relates to an apparatus, a method and a computer program product for translating an input speech and outputting translated speech.

2. Description of the Related Art

Recently, as one of machine translation devices that translate an input speech and output a translated sentence as a translation result, a speech translation system has been developed to assist multi-language communication by translating an speech input from an original language to a translation language and outputting a resultant speech. Moreover, speech communication systems are used to carry out a talk with a speech input by a user and a speech output to a user.

In connection with these speech translation systems and speech communication systems, a technology called barge-in is proposed, for example, according to Japanese Patent No. 3513232. With the barge-in technology, when a user inputs an interrupting speech while a system is outputting a speech to users, the system changes an output control procedure such that the system stops outputting the speech, or changes timing to resume playing an output speech in accordance with contents of the speech given by the user.

However, the method according to Japanese Patent No. 3513232 is a technology that is designed for a talk between the system and the user one to one, so that the system cannot manage processing for an interrupting speech that often arises in a system for intermediately transferring talks between a plurality of users, such as a speech translation system.

For example, in a speech translation system, while the system is outputting a translated speech of a speech given by a speaker, if a listener gives an interrupting speech, and the listener uses a different language form the speaker, the system needs to inform the initial speaker about the interrupting speech without disrupting the talk. However, the conventional barge-in system allows the system only to suppress its output speech against the interrupting speech, and cannot manage an interrupting speech processing to avoid impairing naturalness of the talk between the users.

### SUMMARY OF THE INVENTION

According to one aspect of the present invention, a machine translation apparatus includes a receiving unit that receives an input of a plurality of speeches; a detecting unit that detects a speaker of a speech from among the speeches; a recognition unit that performs speech recognition on the speeches; a translating unit that translates a recognition result to a translated sentence; an output unit that outputs the translated sentence in speech; and an output control unit that controls output of speech by referring to processing stages from receiving to outputting a first speech that is input first from among a plurality of the speeches, a speaker detected with respect to the first speech, and a speaker detected with respect to a second speech that is input after the first speech from among a plurality of the speeches.

According to another aspect of the present invention, a machine translation method includes receiving an input of a plurality of speeches; detecting a speaker of a speech from among the speeches; performing speech recognition on the speeches; translating a recognition result to a translated sentence; outputting the translated sentence in speech; and controlling output of speech by referring to processing stages from receiving to outputting a first speech that is input first from among a plurality of the speeches, a speaker detected with respect to the first speech, and a speaker detected with respect to a second speech that is input after the first speech from among a plurality of the speeches.

A computer program product according to still another aspect of the present invention causes a computer to perform the method according to the present invention.

### BRIEF DESCRIPTION OF THE DRAWINGS

FIG. 1 is a schematic view for explaining a scene where a translation apparatus is used;

FIG. 2 is a functional block diagram of a translation apparatus according to a first embodiment of the present invention;

FIG. 3 is a table for explaining rules under which the translation apparatus shown in FIG. 1 decides on an output procedure;

FIG. 4 is a flowchart of speech translation processing according to the first embodiment;

FIG. 5 is a flowchart of an information detecting process according to the first embodiment;

FIG. 6 is a flowchart of an output-procedure deciding process according to the first embodiment;

FIGS. 7 to 11 are schematic views for explaining output contents output by the translation apparatus shown in FIG. 1;

FIGS. 12 to 14 are schematic views for explaining correspondence between speeches according to the first embodiment;

FIG. 15 is a functional block diagram of a translation apparatus according to a second embodiment of the present invention;

FIG. 16 is a schematic view for explaining an exemplary data structure of a language information table according to the second embodiment;

FIG. 17 is a flowchart of an output-procedure deciding process according to the second embodiment;

FIG. 18 is a schematic view for explaining an exemplary thesaurus dictionary according to the second embodiment;

FIG. 19 is a schematic view for explaining an example of referent extraction according to the second embodiment;

FIG. 20 is a schematic view for explaining an exemplary display method for a display unit according to the second embodiment;

FIG. 21 is a schematic view for explaining an example of correspondence extracting processing in example sentence translation according to the second embodiment;

FIG. 22 is a functional block diagram of a translation apparatus according to a third embodiment of the present invention;

FIG. 23 is a table for explaining rules under which the translation apparatus shown in FIG. 22 decides on an output procedure;

FIG. 24 is a flowchart of an output-procedure deciding process according to the third embodiment;

FIG. 25 is a functional block diagram of a translation apparatus according to a fourth embodiment of the present invention;

FIG. 26 is a flowchart of an output-procedure deciding process according to the fourth embodiment;

FIG. 27 is a schematic view for explaining an example of a speech and translation results according to the fourth embodiment; and

FIG. 28 is a block diagram of hardware configuration of the translation apparatus according to embodiments of the present invention.

### DETAILED DESCRIPTION OF THE INVENTION

Exemplary embodiments of the present invention will be explained below in detail with reference to accompanying drawings.

A translation apparatus according to a first embodiment controls a procedure of outputting a translation result in accordance with information about a speaker who makes an interrupting speech and a processing state of speech translation processing. In the following description, principally explained is machine translation from Japanese to English, however, a combination of an original language and a translation language is not limited to this, and any combination of any language can be applied to the machine translation according to the first embodiment.

FIG. 1 depicts an example case where three speakers, namely, speaker A, speaker B, and speaker C, mutually talk via a translation apparatus 100. In other words, the translation apparatus 100 intermediates a talk between speakers by translating a speech given by any one of the speakers to a language that another of the speakers uses, and outputting translation in speech. The speakers are not limited to three, but can be any numbers of people more than one for the translation apparatus 100 to intermediate their talk.

The translation apparatus 100 exchanges speeches between the speakers via headsets 200a, 200b, and 200c, each of which includes a loudspeaker and a microphone. According to the first embodiment, it is assumed that a speech of each of the speaker is individually captured into the translation apparatus 100. The headsets 200a, 200b, and 200c have a common function, so that they are sometimes simply referred to as a headset 200 or headsets 200 in some following description. The means for inputting a speech is not limited to the headset 200, and any method which allows each speaker to input his/her speech individually can be used.

It can be configured to estimate the direction of a sound source by using a plurality of microphones like a microphone array, and using a difference between time periods within which a sound reaches to respective microphones from the sound source and a difference in the strength of sound pressures, and to extract a speech by each speaker.

Furthermore, in the first embodiment, it is assumed that an original voice spoken by a speaker can be heard by the other speakers. However, it can also be configured that the other speakers cannot hear an original speech given by an original speaker, precisely, the other speakers can hear only a speech output of a translation result output from the translation apparatus 100. Moreover, it can be configured that a speaker can listen to a translation result of his/her own speech when outputting the translation result of the speech given by the speaker.

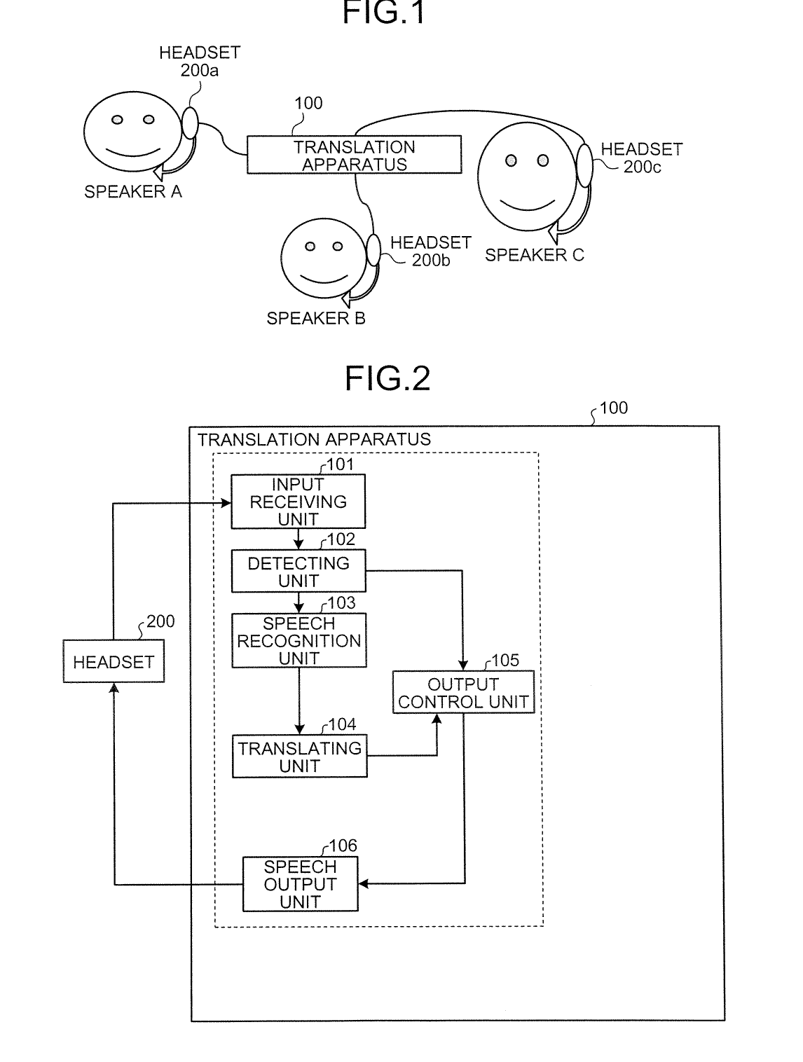

As shown in FIG. 2, the translation apparatus 100 includes, an input receiving unit 101, a speech recognition unit 103, a detecting unit 102, a translating unit 104, an output control unit 105, and a speech output unit 106.

The input receiving unit 101 receives a speech given by a user. Specifically, the input receiving unit 101 converts the speech input from the headset 200 used by each speaker as shown in FIG. 1 into an electric signal (speech data), then converts the speech data from analog to digital into digital data in accordance with the pulse code modulation (PCM) system, and outputs the converted digital data. Such processing can be performed in a manner similarly to a conventionally-used digitizing processing for speech signals.

Moreover, the input receiving unit 101 outputs information that can identifies an input source, precisely, an identifier of a microphone of each of the headsets 200 worn by respective speakers. When using a microphone array, the input receiving unit 101 outputs information about an estimated sound source as information for identifying the input source instead of the identifier of the microphone.

The detecting unit 102 detects presence or absence of speech input and a time duration within which the speech is input (speech duration), and detects a speaker of the speech input source. Specifically, the detecting unit 102 detects a time period as the speech duration if the period of a sound continues relatively longer than a threshold. The method of detecting the speech duration is not limited to this, but also any speech-duration detecting technology that has been conventionally used can be applied, for example, a method to detect a time period as a speech duration if the time period has a strong likelihood of a speech model obtained from results of frequency analyses of speeches.

Moreover, the detecting unit 102 determines the speaker of the input source from the identifier of the microphone output from the input receiving unit 101 by referring to corresponding information between pre-stored identifiers of microphones and speakers. When using a microphone array, the detecting unit 102 can be configured to estimate the speaker from information about an estimated sound source direction. Furthermore, the detecting unit 102 can be configured to detect the speaker by any method, for example, a method to discriminate whether an input speech is that of a registered speaker by using a speaker identifying technology that has been conventionally used.

The detecting unit 102 outputs a speech signal extracted from each of the speakers and a detection result of the speech duration.

The speech recognition unit 103 performs speech recognition processing on the speech signal output from the detecting unit 102. Any speech recognition method that is generally used by using the linear predictive coding (LPC) analysis, the hidden Markov model (HMM), the dynamic programming, the neural network, the N-gram language model, or the like, can be applied to the speech recognition processing.

The translating unit 104 translates a recognition result obtained by the speech recognition unit 103. A language of the source for translation (original language) and a language of a translated product (translation language) are determined by referring to information stored in a storage unit (not shown) that is preset by each of the speakers.

Any translation technology that has been conventionally used can be applied to translation processing performed by the translating unit 104: for example, an example-sentence translation technology by which a translated sentence (translation result) corresponding to a speech input is output by searching example sentences set for input speech, a rule-based translation technology by which a translated sentence (translation result) is output by translating an input speech under a statistic model and predetermined rules, or the like.

It is assumed that other units can obtain a result of processing performed by the speech recognition unit 103 and the translating unit 104 as required.

The output control unit 105 decides on the output procedure of the translation result in accordance with a predetermined rule by referring to: processing states of various processing such as speech receiving processing, the speech recognition processing, the translation processing, and output processing of the translation result; information about speakers; and information about an interrupting speech.

The speech output unit 106 outputs a translated sentence (translation result) translated by the translating unit 104 in speech by voice synthesis, for example.

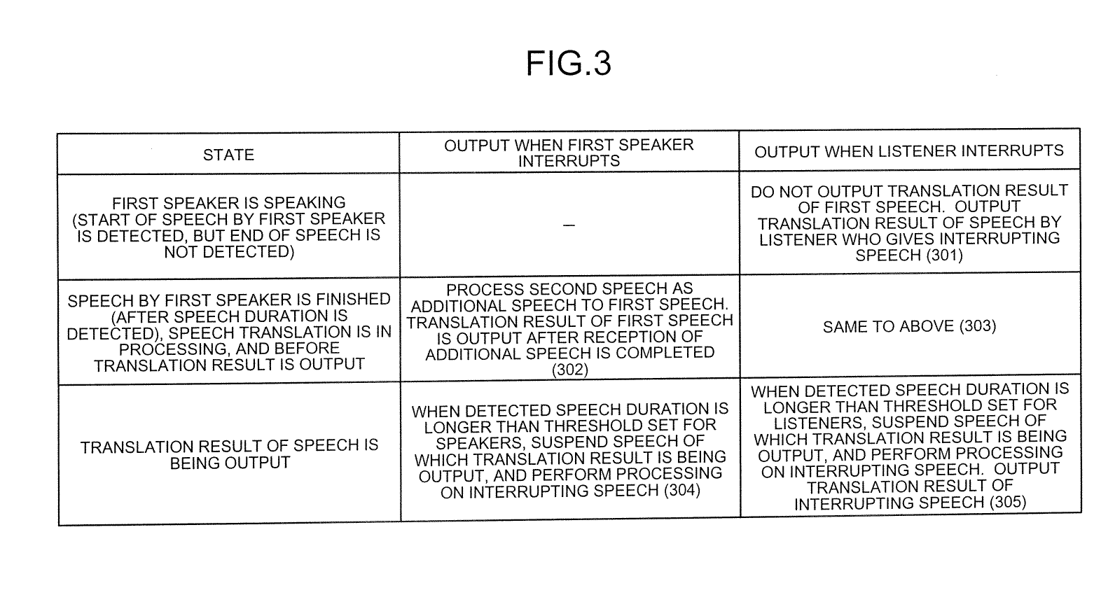

In FIG. 3, shown is an example of rules relating to details of output processing that is performed, when an interrupting speech is input, appropriately to a processing state of a speech that is interrupted by the interrupting speech, and a speaker who makes the interrupting speech. Details of processing to be performed by the output control unit 105 for deciding an output procedure will be explained later.

The output control unit 105 outputs the translation result translated by the translating unit 104 via the speech output unit 106. When outputting, the output control unit 105 outputs the translation result as a synthetic voice in the translation language. Any method of synthesizing a voice that is generally used can be applied to the voice synthesis processing performed by the speech output unit 106, for example, voice synthesis by compilation of phoneme, the formant voice synthesis, and the voice-corpus-based voice synthesis.

It can be configured that various outputs and display means, such as text output in the translation language onto a display device that displays a text on its screen or output of the translation result into a printed text by a printer, can be performed together with or substituted for the speech output performed by the speech output unit 106.

Basic processing performed by the translation apparatus 100 that has the above configuration is described below. To begin with, when a speaker speaks, the input receiving unit 101 receives a speech, and the detecting unit 102 detects a speech duration and the speaker. By referring to predetermined language information, speech recognition and translation are then performed on the input speech, and a translation result is output by synthesizing a voice. The other users listen to a translated synthetic voice, and can understand the contents of the speech given by the speaker. When an interrupting speech is made during such basic processing of speech translation, a method according to the first embodiment allows the translation apparatus 100 to output a translation result appropriately without disrupting a talk.

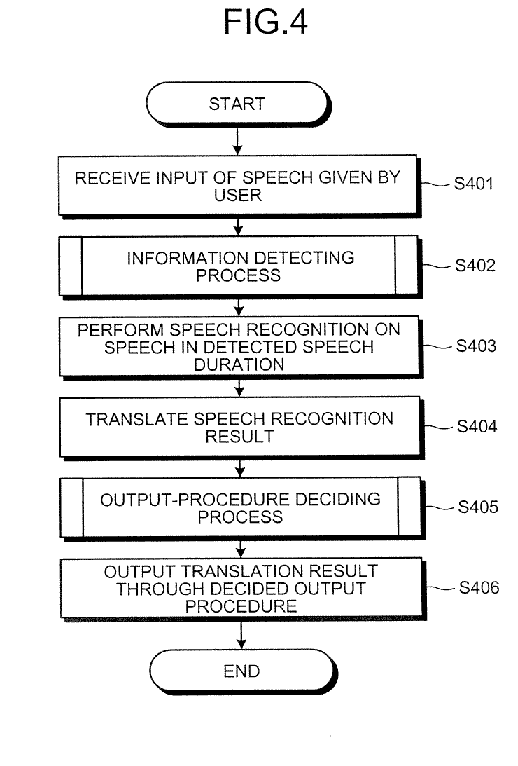

Next, speech translation processing including the basic speech translation processing performed by the translation apparatus 100 is explained below with reference to FIG. 4.

To begin with, the input receiving unit 101 receives input of a speech given by a user (step S401). Specifically, the input receiving unit 101 converts the speech input from a microphone of the headset 200 into an electric signal, then converts speech data from analog to digital, and outputs the converted digital data of the speech.

Next, the detecting unit 102 performs an information detecting process to detect a speech duration and information about the speaker from the speech data (step S402).

Next, the speech recognition unit 103 performs the speech recognition processing on the speech in the speech duration detected by the detecting unit 102 (step S403). The speech recognition unit 103 performs the speech recognition processing by using a conventional speech recognition technology as described above.

Next, the translating unit 104 translates a speech recognition result obtained by the speech recognition unit 103 (step S404). The translating unit 104 performs the translation processing by using a conventional translation technology, such as the example-sentence translation or the rule-based translation, as described above.

Next, the output control unit 105 decides to adopt an output procedure (step S405).

Subsequently, the speech output unit 106 outputs a translation result according to the output procedure decided by the output control unit 105 (step S406), and then the speech translation processing is terminated.

Hereinafter, a predetermined processing time unit is referred to as a frame. In FIG. 4, to simplify explanation, processing executed per frame (the information detecting process, and the output-procedure deciding process), and processing executed per detected speech duration (the speech recognition processing, the translation processing, and the output control processing) are described continuously. In practice, each processing is performed in parallel. For example, depending on a decision decided by the output control unit 105, the translation processing in execution can be suspended in some cases.

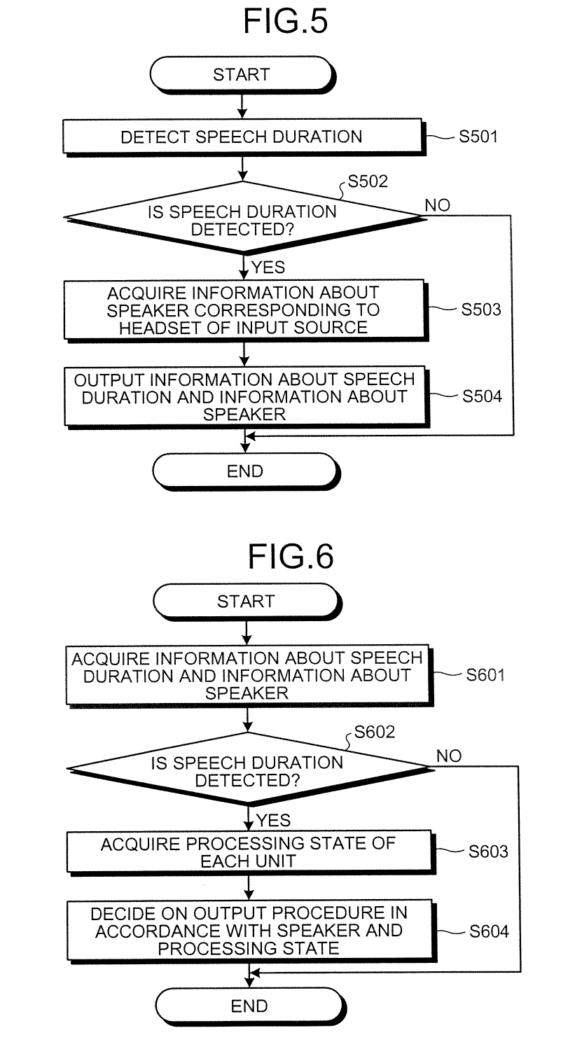

Next, details of the information detecting process at step S402 is explained below with reference to FIG. 5. The information detecting process is to be performed per frame similarly to general speech recognition and a talk technology. For example, suppose 10 milliseconds is one frame. If a speech is input between the first second and the third second after the system is started, this means that speech input is present between the 100th frame and the 300th frame.

By dividing the processing into each time unit in this way, the speech recognition processing and the translation processing can be performed in parallel before speech input is finished; for example, if a speech signal equivalent to 50 frames is input, those processing are started; so that a processing result can be output at a time point close to the end of the input speech.

In the following description, it is assumed that a speech is input via a microphone by a user, the speech can be separately processed with respect to each microphone, and speaker information about the user of each microphone relevant to speech translation, namely, a spoken language and an output language in response to a speech input, are specified in advance by each user.

FIG. 5 is a flowchart of processing per frame performed by the detecting unit 102 onto a signal input from an individual microphone. The processing shown in FIG. 5 is performed per frame with respect to each microphone.

To begin with, the detecting unit 102 detects a speech duration based on a signal in a frame in processing input from the microphone (step S501). If the detecting unit 102 needs to detect the speech duration based on information about a plurality of frames, the detecting unit 102 can determines that the speech duration starts from a frame going back by required number of frames previous to the current point.

The detecting unit 102 then determines whether the speech duration is detected (step S502). If any speech duration is not detected (No at step S502), the detecting unit 102 determines that no speech is input in the frame from a user, and terminates the processing, and then another processing such as the translation processing is executed.

If the speech duration is detected (Yes at step S502), the detecting unit 102 acquires information about a speaker corresponding to the headset 200 of the input source by referring to the preset information (step S503). The case where the speech duration is detected can include a case where the speech duration is detected subsequently to the previous frame, and a case where the speech duration is detected for the first time.

The detecting unit 102 then outputs information indicating that the speech duration is detected, and the acquired information about the speaker (step S504), and terminates the information detecting process.

A period between a starting frame in which detection of the speech is started and an ending frame after which the speech is not detected is the speech duration. In the above example, from the 100th frame to the 300th frame, the speech is detected from the processing performed on the microphone, and the detecting unit 102 outputs information about the detected speech together with information about the speaker. Thus, presence or absence of speech input from a user and information about a speaker when the speech input is present can be acquired by the detecting unit 102.

Next, details of the output-procedure deciding process at step S405 is explained below with reference to FIG. 6. To explain this, it is assumed that the output-procedure deciding process is also performed per frame similarly to the information detecting process.

To begin with, the output control unit 105 acquires information about the speech duration and information about the speaker output by the detecting unit 102 (step S601). The output control unit 105 then determines whether the speech duration is detected by referring to the acquired information (step S602).

If any speech duration is not detected (No at step S602), the output control unit 105 performs nothing, or continues processing that has been determined and performed until the previous frame, and terminates the output-procedure deciding process in the current frame. The case where no new speech duration is detected includes a case where no speech is present, and a case where the detected speech is the same as the speech in the previous frame.

If the speech duration is detected (Yes at step S602), the output control unit 105 acquires a state of processing in execution by each unit (step S603). The output control unit 105 then decides on the output procedure for the translation result in accordance with the speaker and the processing state of each unit (step S604).

Specifically, the output control unit 105 decides on the output procedure according to rules as shown in FIG. 3.

Although not shown in FIG. 3, explained below is the output-procedure deciding process in a case where a new speech duration is detected while the translating unit 104 is not performing processing and not outputting any speech of a translation result. In this case, the output control unit 105 continues the processing that has been detected until the previous frame. In other words, because this case is not an interrupting speech, the processing determined and continued in the previous frame, such as the input receiving processing or the translation processing, is continued.

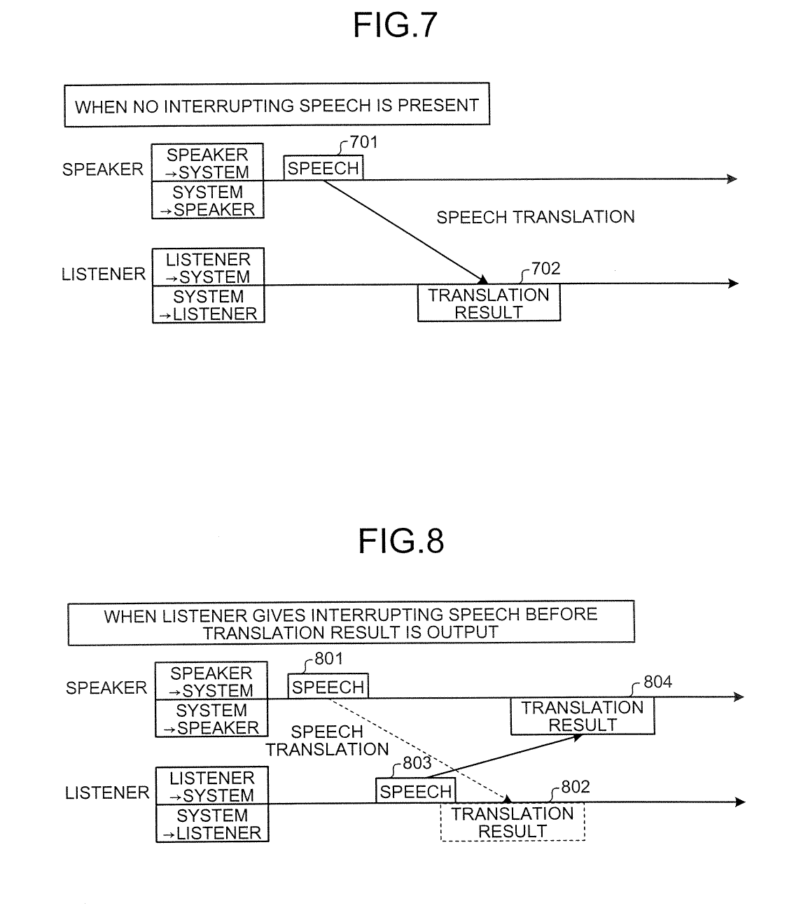

FIG. 7 is a schematic view for explaining an example of output contents in this case. As shown in FIG. 7, there is no interrupting speech into a speech 701 by a speaker, so that translation processing is performed after the speech 701 is finished, and then a translation result 702 is output to a listener.

In FIG. 7, the horizontal axis represents a time axis, which indicates at what timing the translation result is returned to the listener when the speaker speaks. The arrow describes that the speech corresponds to the translation result. FIG. 7 depicts the example where the translation result is output after the speech is finished, however, it can be configured that the translation processing is simultaneously performed as like simultaneous interpretation, and the output of the translation result is started before the ending of the speech duration detection.

Next, examples applicable to the rules shown in FIG. 3 are explained below. In the first case, it is assumed that a new speech is detected when another speech has been already detected and its end has not been detected yet. The first case corresponds to an output procedure 301 in FIG. 3, where a listener interrupts while a first speaker is speaking (first speech).

In the first case, the listener speaks without waiting output of a translation result, therefore, the first speech is unwanted for the listener, who has made the interrupting speech. The output control unit 105 then selects the output procedure for outputting only a translation result of the interrupting speech given by the listener without outputting the translation result of the first speech given by the first speaker.

FIG. 8 is a schematic view for explaining an example of output contents in the first case. As shown in FIG. 8, after the speaker gives a speech 801 at first, under normal circumstances, the speech translation is performed, and then a translation result 802 is output. However, the listener makes an interrupting speech 803 in the first case, the output of the translation result 802 is suppressed, while a translation result 804 of the interrupting speech 803 is output. The broken line in FIG. 8 indicates that the output is suppressed.

The most simple way of suppressing output of the translation result is that the speech output unit 106 does not output speech. Thus, when the listener needs to speak to the speaker urgently, a talk with less waiting time can be achieved by suppressing the output of the translation result of the first speech given by the first speaker. The method of suppressing the output is not limited to this, and any method can be applied, for example, the volume of the output is turned down so that the output is suppressed.

In the second case, it is assumed that a new speech is detected when the end of the speech duration of the first speech given by the first speaker is detected and the translation processing of the first speech is in execution, meanwhile its translation result has not been output yet. In the second case, if a speaker of the new speech is the same as the first speaker, the new speech can be considered as an additional speech to the first speech.

The second case corresponds to an output procedure 302 in FIG. 3, where the first speaker interrupts when the first speaker finishes the first speech, and the speech translation is in processing, and before the translation result of the first speech is output. In the second case, the output control unit 105 performs the translation processing on the two speeches together, and decides on an output procedure to output a translation result corresponding to the two speeches.

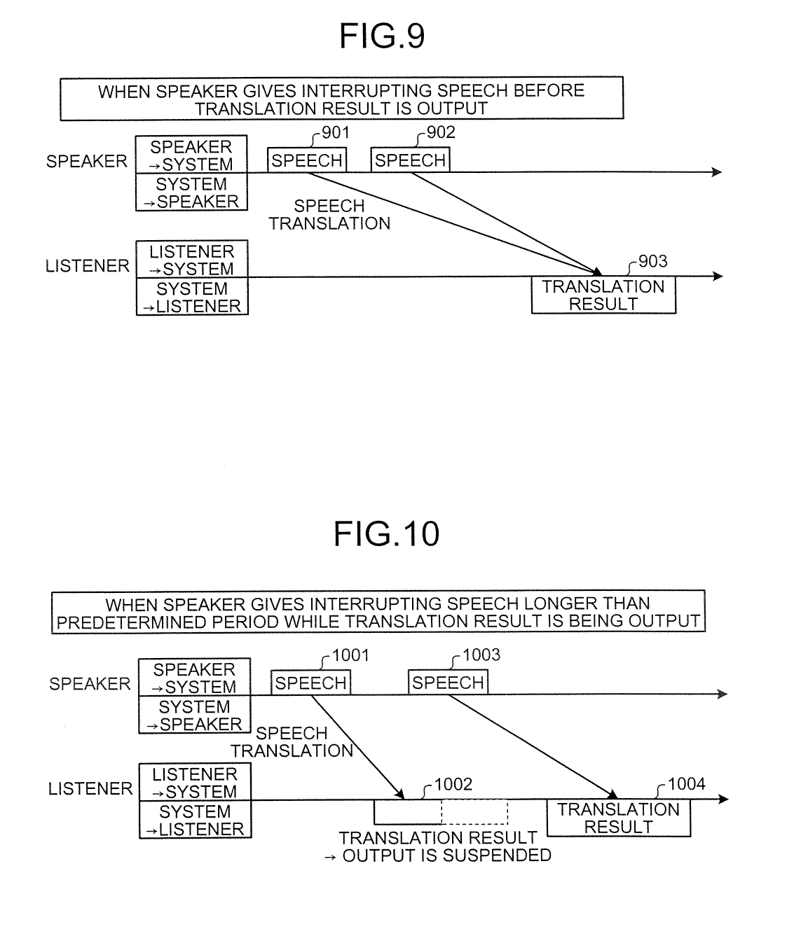

FIG. 9 is a schematic view for explaining an example of output contents in the second case. As shown in FIG. 9, after the first speaker gives a speech 901 at first, a next speech 902 is detected. A translation result 903 corresponding to both of the speech 901 and the speech 902 is then output.

Thus, even if a speech is detected separately into two due to a falter, the speaker can communicate an intention of the speech more precisely by outputting the translation result together into one.

In the third case, it is assumed that a new speech is detected when the end of the speech duration of the first speech given by the first speaker is detected and the translation processing of the first speech is in execution, meanwhile its translation result has not been output; and moreover, a second speaker of the newly detected speech is different from the first speaker. The third case corresponds to an output procedure 303 in FIG. 3, where the listener interrupts when the first speaker finishes the first speech, and the speech translation is in processing, and before a translation result of the first speech is output.

The third case is similar to the first case (the output procedure 301 in FIG. 3) in the aspect that the listener makes the interrupting speech before the translation result of the first speech is output, so that the output control unit 105 decides on the output procedure 303 similar to the output procedure 301.

In the fourth case, it is assumed that when a new speech is detected, the translation result of the first speech that is previously input is being output in speech, and the newly detected speech is also given by the first speaker. The fourth case corresponds to an output procedure 304 in FIG. 3, where the first speaker interrupts while the speech translation result of the first speech is being output.

In the fourth case, if a new speech duration of an interrupting speech exceeds a threshold that is predetermined for speakers, the output control unit 105 suspends speech output of the translation result in execution, and decides on an output procedure to output a translation result in speech of the interrupting speech.

FIG. 10 is a schematic view for explaining an example of output contents in the fourth case. As shown in FIG. 10, it is assumed that the speaker gives a speech 1001 at first, and then a translation result 1002 of the speech 1001 is being output. During output of the translation result 1002, the same speaker gives an interrupting speech 1003, and if the length of the interrupting speech 1003 exceeds the threshold predetermined for speakers, output of the translation result 1002 is suspended, and a translation result 1004 of the interrupting speech 1003 is output.

Thus, the speaker can correct the first speech and give a new speech without special operation. Moreover, the translation apparatus 100 interrupts output of the translation result of the previous speech, only if the duration of the interrupting speech exceeds the threshold for speakers, thereby reducing false interruptions that the output is interrupted by an irrelevant noise, such as a cough, made by the speaker.

In the fifth case, it is assumed that when a new speech is detected, the translation result of the first speech that is previously input is still being output, and a speaker of the newly detected speech is the listener. The fifth case corresponds to an output procedure 305 in FIG. 3, where the listener interrupts while the speech translation result is being output.

In the fifth case, the situation can be presumed that the listener desires to speak even by interrupting a statement given by the speaker. However, false operation caused by a cough, an insignificant nod, or the like, should be avoided. For this reason, if the duration of a new interrupting speech exceeds a threshold predetermined for listeners, the output control unit 105 suspends speech output of the translation result in execution, and decides on an output procedure to output a speech translation result in speech of the interrupting speech.

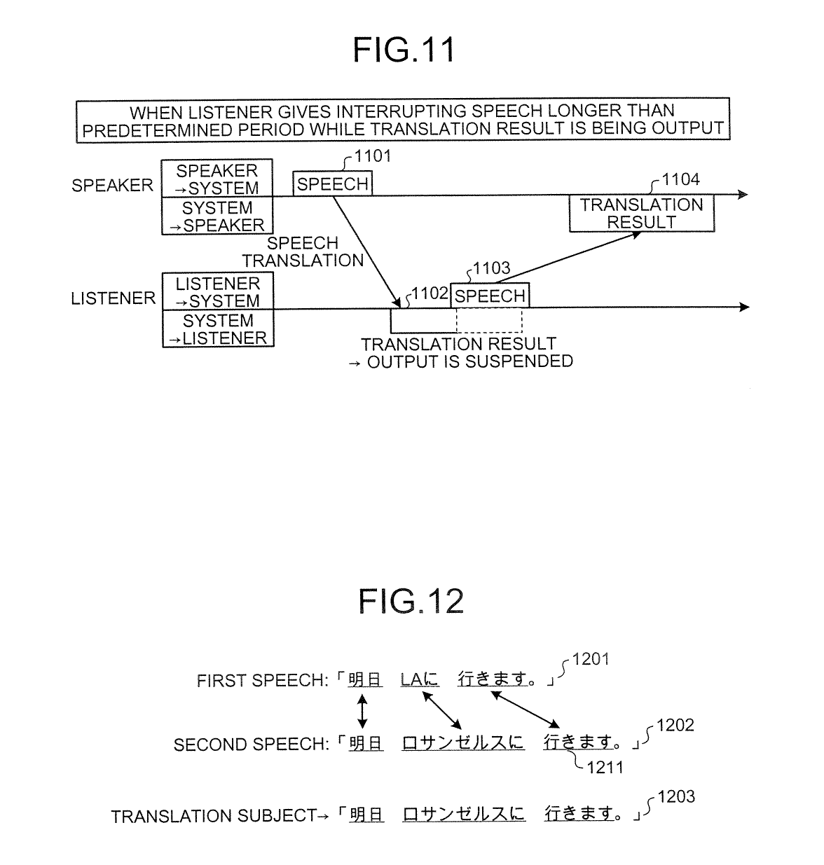

FIG. 11 is a schematic view for explaining an example of output contents in the fifth case. As shown in FIG. 11, while a translation result 1102 is being output in response to a speech 1101 given by the first speaker, the listener gives an interrupting speech 1103, and if the length of the interrupting speech 1103 exceeds the duration predetermined for speakers, the translation apparatus 100 suspends output of the translation result 1102, and a translation result 1104 of the interrupting speech 1103 given by the listener is output.

Thus, the listener can make an instant response to the translation result of the speech given by the first speaker, and can communicate contents of the response to the first speaker as quickly as possible. Moreover, the listener can give an interrupting speech against the speech given by the speaker, and can talk without listening to an unwanted speech.

By setting different thresholds for a speaker and a listener respectively as a time period for detecting an interrupting speech, suitable processing can be performed for each user who gives an interrupting speech. Precisely, when the first speaker gives an interrupting speech, the first speaker is unlikely to make a nod to him/herself, so that a threshold is set to a sufficient time period for rejecting irrelevant words including a cough. On the other hand, in the case for the listener, it is not desirable that the translation result of the speech given by the speaker is interrupted by a nod made by the listener, so that a threshold is set to a time period relatively longer than a simple nod.

Thus, the translation apparatus 100 according to the first embodiment can control translation results to be output in accordance with the information about the speaker who gives the interrupting speech and the processing state of the speech translation processing. Accordingly, output of the translation result of the interrupting speech can be appropriately controlled without disrupting the talk. Furthermore, the translation apparatus 100 can perform the translation processing on speeches between users in a manner as natural as possible, and output its translation result.

In addition, the following modification is conceivable in relation to the output procedure 302, when the first speaker gives an interrupting speech, after the speech of the first speaker is terminated and being translated and before outputting the translated result of the speech.

It can be configured that the output control unit 105 determines that the latter speech is a correction speech to the first speech, and then decides on an output procedure to replace the translation result of the first speech with a translation result of the latter speech replaces and to output it.

Moreover, if the correspondence of the latter speech to the first speech is established, the output control unit 105 can be configured to decide on an output procedure to output a result including the latter speech that replaces corresponding part in the first speech. An example of output contents in this case is explained below with reference to FIGS. 12 to 14.

In an example in FIG. 12, a morphological analysis and a parsing syntactic analysis are performed on a first speech 1201, which means “I'm going to LA tomorrow” in Japanese, as a result, the speech 1201 is divided into three blocks. The same analyses are performed on a latter (second) speech 1202, which means “I'm going to Los Angeles tomorrow”, and if the speech 1202 is divided into three blocks 1211, the dynamic programming (DP) matching is performed between two sets of three blocks to estimate correspondence between each of the blocks.

As a result, it is determined that the second block is restated in this example, so that the second block of the latter speech replaces the second block of the first speech, and the translation processing is performed on a speech 1203, which means “I'm going to Los Angeles tomorrow”.

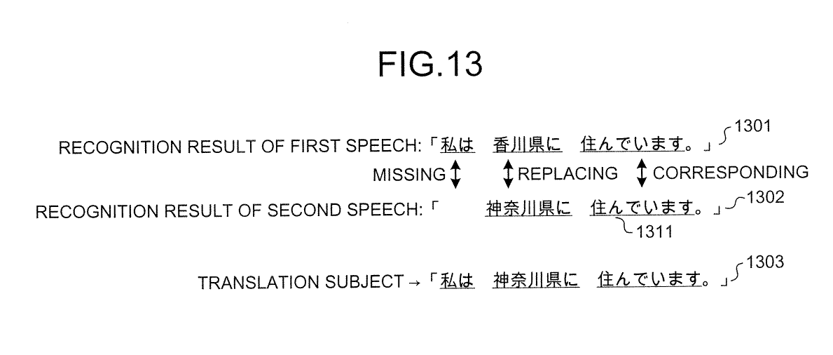

In an example in FIG. 13, although a user gives a first Japanese speech that means “I'm living in Kanagawa prefecture”, due to false recognition, a recognition result 1301 that means “I'm living in Kagawa prefecture” is output, for example, onto a not shown display device. The user then gives a second Japanese speech 1302 without a grammatical subject “living in Kanagawa prefecture” (1311) to correct an error in the recognition result 1301.

In this case, the grammatical subject is omitted in the second speech, so that only two blocks are extracted from the second speech into an analysis result. Subsequently, the DP matching is performed similarly to the above example, it is determined, for example, as follows: in the second speech, a first block is missing, a second block is replaced, and a third block is an equivalent, against the first speech. Accordingly, the second block from among the three blocks of the first speech is replaced with the corresponding block in the second speech, so that the translation processing is performed on a speech 1303 that means “I'm living in Kanagawa prefecture”.

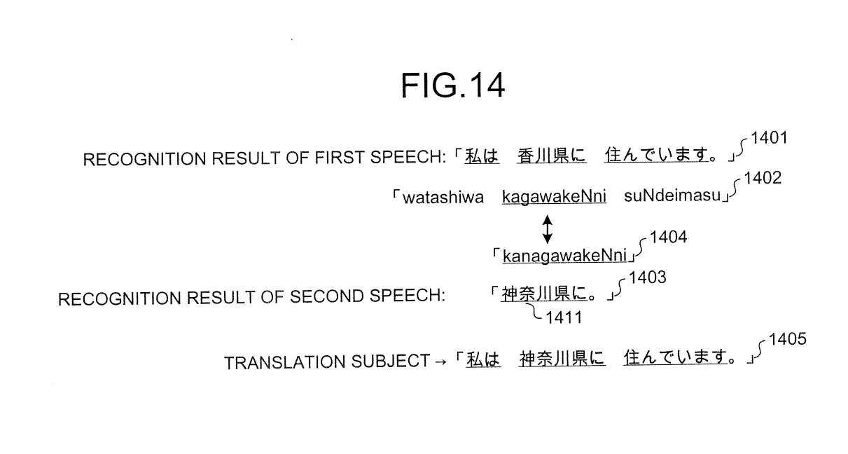

In FIG. 14, a recognition result 1401 that means “I'm living in Kagawa prefecture” and corresponding phonemes 1402 are described. In this example, only a character string 1403 (“in Kanagawa prefecture”) corresponding to an erroneous block is spoken, and phonemes 1404 of the character string 1403 are described.

In this way, the DP matching is performed on the speeches described in phonemes, and if the quantity of phonemes in a corresponding duration is larger than a predetermined quantity, and the degree of matching is larger than a threshold, it can be determined that the second speech is a restatement of part of the first speech.

For example, the predetermined quantity is set to six phonemes (equivalent to approximately three syllables). As a calculating method for the degree of matching, the threshold is set to, for example, 70% by using a phoneme accuracy. The phoneme accuracy (Acc) is calculated according to the following Equation (1):

Acc=100×(total phoneme quantity−missing quantity−insertion quantity−replacement quantity)/total phoneme quantity (1)

The total phoneme quantity refers to the total number of phonemes in the corresponding part of the first speech. The missing quantity, the insertion quantity, and the replacement quantity refer to quantities of phonemes in the second speech that are deleted, added, and replaced, respectively, against the first speech.

In the above example, the total phoneme quantity of “KagawakenNni” is 11, the missing quantity is zero, the insertion quantity is two (“na”), and the replacement quantity is zero with respect to “KanagawakenNni”, so that Ace is 82%. In this case, the phoneme quantity (11) is larger than the predetermined quantity (6), and the degree of matching is larger than the threshold (70%), therefore, it is determined that the second speech is a restatement speech. As a result, the corresponding part of the first speech is replaced with the restatement speech, so that the translation processing is performed on a speech 1405 that means “I'm living in Kanagawa prefecture”.

Thus, when correspondence is established between the second speech and the first speech, the second speech is determined as a restatement of the second speech, and the first speech is corrected with the second speech, consequently, the speaker can communicate an intention of the speech more precisely.

A translation apparatus 1500 according to a second embodiment specifies a point of an interruption during a first speech and a point in the first speech corresponding to a demonstrative word included in an interrupting speech, to present contents of an original speech given by a speaker to the speaker.

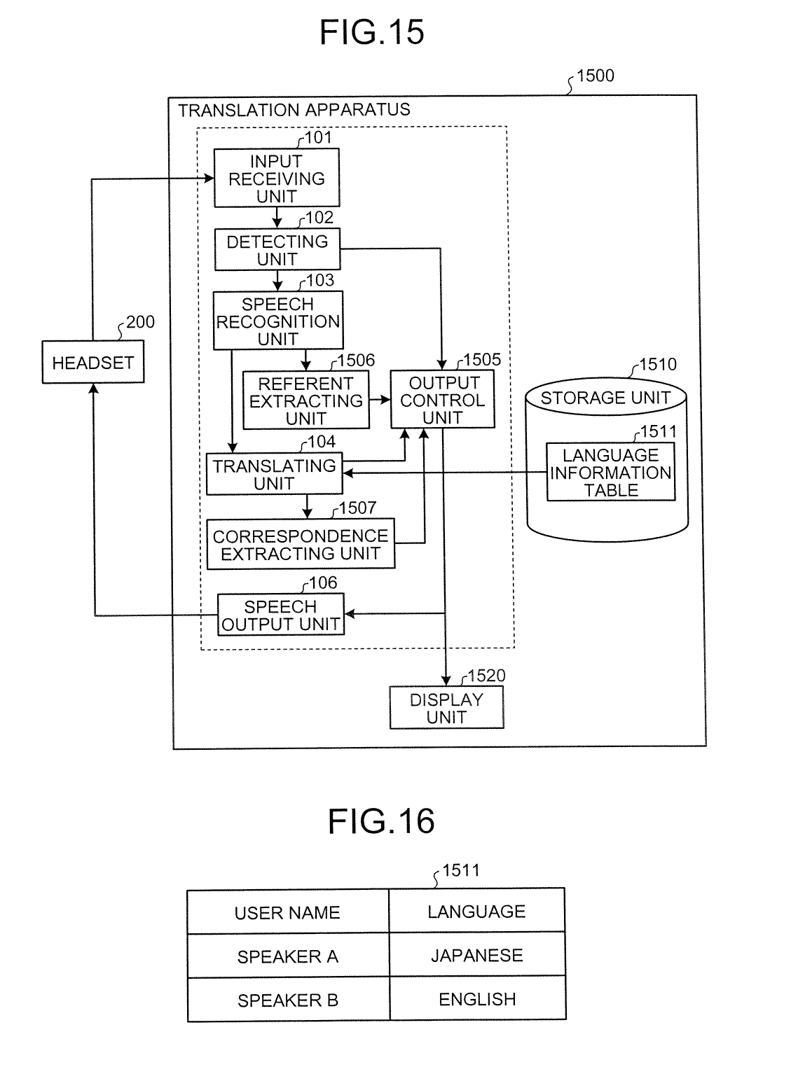

As shown in FIG. 15, the translation apparatus 1500 includes a storage unit 1510, a display unit 1520, the input receiving unit 101, the speech recognition unit 103, the detecting unit 102, the translating unit 104, an output control unit 1505, a referent extracting unit 1506, and a correspondence extracting unit 1507.

In the second embodiment, the translation apparatus 1500 differs from the first embodiment in adding the storage unit 1510, the display unit 1520, the referent extracting unit 1506, and the correspondence extracting unit 1507, and the output control unit 1505 functions differently from the first embodiment. Because the other units and functions of the translation apparatus 1500 are the same to the block diagram of the translation apparatus 100 according to the first embodiment shown in FIG. 1, the same reference numerals are assigned to the same units, and explanations for them are omitted.

The storage unit 1510 stores therein a language information table 1511 that stores therein information about languages of respective speakers. The language information table 1511 can be configured with any recording media that is generally used, such as a hard disk drive (HDD), an optical disk, a memory card, and a random access memory (RAM).

As shown in FIG. 16, the language information table 1511 stores therein in associated manner information (user name) that uniquely identifies a speaker, and information (language) of the original language that the speaker uses.

According to the first embodiment, the translation apparatus 100 performs translation based on information prespecified by each speaker about from which language to which language the translation is to be performed. In contrast, according to the second embodiment, by using the language information table 1511, the translation apparatus 1500 can use initially set languages until a speaker changes without re-entry of language information.

Moreover, by using the language information table 1511, the output control unit 1505 can output a translation result in a translation language only to user(s) who uses the translation language. For example, when a Japanese user, an English user, and a Chinese user use the translation apparatus 1500, the translation apparatus 1500 can be configured such that, in response to a speech given by the Japanese user, an English translation result is output only to the English user, while a Chinese translation result is output only to the Chinese user.

The display unit 1520 is a display device that can display a recognition result obtained by the speech recognition unit 103, and a translation result obtained by the translating unit 104. Display contents can be changed by accepting an instruction form the output control unit 1505. Various examples are conceivable about the number of units of the display unit 1520 and display contents. Here, as an example in this case, it is assumed that every user is provided with one unit of the display unit 1520 that allows the user to watch and listen to, and contents of an interrupted speech before translation are displayed to a speaker of the interrupted speech.

The referent extracting unit 1506 extracts a referent that a demonstrative word included in the interrupting speech indicates from a translation result of the interrupted speech. Specifically, if a demonstrative word, such as a pronoun, is included in the interrupting speech given by a speaker different from the first speaker, the referent extracting unit 1506 picks out a part of the interrupted speech that is output until the interrupting speech starts, and extracts a noun phrase or a verb phrase corresponding to the demonstrative word in the interrupting speech from the interrupted speech.

The correspondence extracting unit 1507 extracts correspondence between words in a recognition result of a speech before translation and words in a translation result of the speech. Hereinafter, a word in an original sentence is referred to as an original language word, and a word in a translated sentence is referred to as a translated word. When the translation processing is performed by the rule-based translation, the translating unit 104 parses the recognition result that is an input sentence for the translation processing, converts a tree of a analysis result under predetermined rules, and replaces an original language word with a translated word. In this case, the correspondence extracting unit 1507 can extracts correspondence between an original language word and a translated word by comparing between tree-structures of before and after converting.

In addition to the functions of the output control unit 105 according to the first embodiment, the output control unit 1505 includes a function that displays onto the display unit 1520 the input sentence attached with information about the demonstrative word and information relevant to the interruption to the speech by referring to an extraction result obtained by the referent extracting unit 1506 and the correspondence extracting unit 1507.

Specifically, the output control unit 1505 displays a part of the input sentence corresponding to a referent extracted by the referent extracting unit 1506, with attaching a double underline, onto the display unit 1520. Moreover, the output control unit 105 displays part of the input sentence corresponding to a translation result that has been output by the time point when the interrupting speech starts, by attaching underlines, onto the display unit 1520. The displaying style for a corresponding pat is not limited to an underline or a double underline, and any style that can distinguish the corresponding part from other words can be applied, for example, by changing any property, such as size, color, or font of character.

Next, speech translation processing performed by the translation apparatus 1500 is explained below. The speech translation processing according to the second embodiment is almost similar to the speech translation processing according to the first embodiment shown in FIG. 4, however, details of the output-procedure deciding process are different.

Specifically, in the second embodiment, in addition to processing that decides contents of a speech output in the same manner to the first embodiment, the translation apparatus 1500 performs processing that decides output contents to be displayed on the display unit 1520. Because these processing are independent, only the latter processing is explained below, however, the former processing similar to the first embodiment is also performed in parallel in practice.

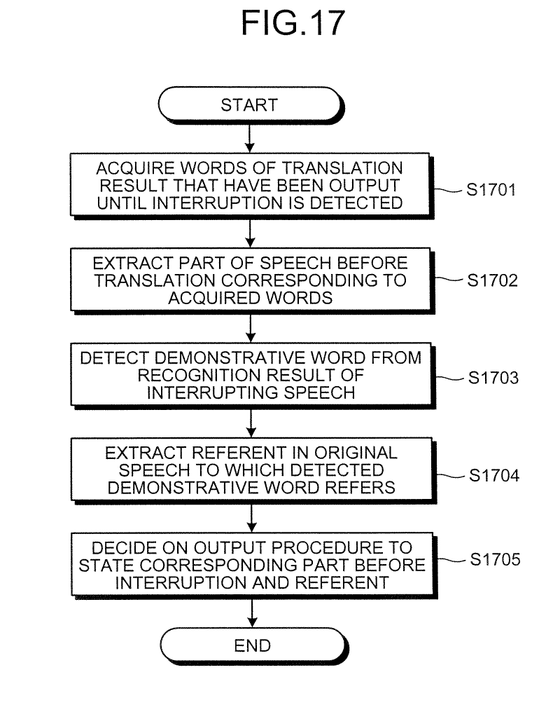

An output-procedure deciding process performed by the translation apparatus 1500 is explained below with reference to FIG. 17.

An individual step of processing that decides output contents to be displayed is not finished within one frame. For this reason, FIG. 17 depicts a flow of processing that is assumed to go to a next step after a required number of frames are acquired and the processing is finished, instead of a flow of processing per frame.

Furthermore, the process shown in FIG. 17 is to be executed, when a new speech is detected during output of a translation result, and its speaker is different from a first speaker. Processing under other conditions is performed similarly to the processing shown in FIG. 6 according to the first embodiment as described above.

To begin with, the output control unit 1505 acquires words in a translation result of an original speech that have been output by detection of an interrupting speech (step S1701).

For example, suppose the first speaker gives a Japanese speech that means “From now, I would like to go to XXX street and YYY street”. As a translation result, the translation apparatus 1500 has created a sentence “From now, I would like to go to XXX street and YYY street”, and is outputting the created translation result.

During output of the translation result, at a time point when a listener hear XXX street, the listener thinks that it is dangerous if the speaker goes there, and gives a speech “The street is dangerous for you”. In this example, “From now, I would like to go to XXX street” is acquired as the words in the translation result of the original speech that have been output by detection of the interrupting speech.

Next, the correspondence extracting unit 1507 extracts a corresponding part in a recognition result of the speech before translation with respect to the acquired words (step S1702). Specifically, the correspondence extracting unit 1507 extracts words in the recognition result corresponding to the words in the translation result by referring to the tree-structures before and after converting that are used for translating.

In the above example, the correspondence extracting unit 1507 extracts four Japanese phrases, corresponding to “From now”, “I would like to”, “go to”, and “XXX street”.

Next, the referent extracting unit 1506 detects a demonstrative word from the recognition result of the interrupting speech (step S1703). When detecting, the output control unit 1505 detects a word working as a demonstrative word by referring to a preregistered word dictionary (not shown), for example. In the above example, the output control unit 1505 acquires “The street” from the recognition result of the interrupting speech as a part working as a pronoun.

The referent extracting unit 1506 then extracts a referent in the original speech that the detected demonstrative word indicates (step S1704). Specifically, the referent extracting unit 1506 extracts the referent in the following process.

The referent extracting unit 1506 parses from a word closest to the interrupted time point among the words included in the recognition result of the interrupted speech, to analyze whether it can replace the demonstrative word in the interrupting speech. Availability of replacement is determined based on a distance between concepts of words, for example, by using a thesaurus dictionary. The thesaurus dictionary is a dictionary in which words are semantically classified, for example, such that an upper class includes words that have general meaning, and a lower class includes more specific words.

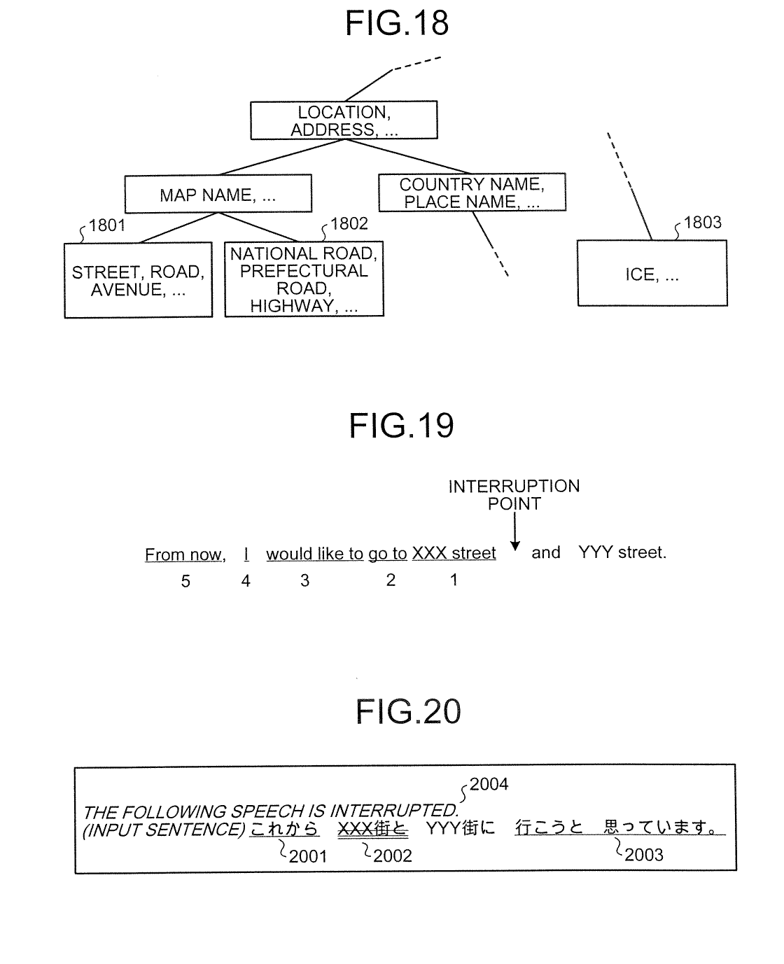

In FIG. 18, words, such as street, road, and avenue, which can be used for name of a local area, for example, “so-and-so street”, are categorized into a node 1801.

By using such thesaurus dictionary, the referent extracting unit 1506 can determines that the shorter distance between nodes is the higher degree of replacement possibility. For example, the distance between the node 1801 to which street belongs to and a node 1802 to which national-road belongs to is two, therefore, it is determined that the degree of replacement possibility is relatively high. In contrast, pronunciations of street and ice in Japanese (touri and kouri) are close to each other, however, the distance between their respective nodes (the node 1801 and a node 1803) is long, therefore, it is determined that the degree of replacement possibility is low.

The referent extracting unit 1506 then calculates a sum of a score indicating a distance between each block of the speech and the interruption point in the speech, and a score indicating a degree of replacement possibility, and presumes a part with high calculated score to be the referent of the demonstrative word. The method of estimating a referent of a demonstrative word is not limited to this, and any method for estimation of demonstrative words in speech interaction technologies can be applied.

In FIG. 19, the translation result of the original speech processed in the above example and numerical values that indicate a distance from the interruption point are shown in associated manner.

The referent extracting unit 1506 parses the words “XXX street”, which is the closest to the interruption point, and the demonstrative words “The street” to determine a replacement possibility. In this example, it is determined that the words in question are replaceable, and it is presumed that “XXX street” is the referent of the demonstrative word.

Returning to FIG. 17, the output control unit 1505 decides on an output procedure that clearly states the corresponding part in the recognition result until the interruption point extracted at step S1702, and the referent extracted at step S1704 (step S1705). Specifically, the output control unit 1505 decides on an output procedure to display the recognition result with attaching underlines to the corresponding parts and a double underline to the referent, onto the display unit 1520.

FIG. 20 is a schematic view for explaining a screen that displays information in Japanese to inform the interruption to a Japanese speaker in the above example.

In the upper area of FIG. 20, a message expressed in a language acquired by referring to the language information table 1511 is displayed. In this example, the message is expressed in Japanese, which is a Japanese message 2004 that means “The following speech is interrupted”.

In addition, the output control unit 1505 displays contents of the speech given by the first speaker, and displays Japanese words 2001 and 2003 corresponding to part that has been output to a listener until the interruption point with attaching underlines. Furthermore, the output control unit 1505 displays Japanese words 2002 corresponding to the closest part to the interruption point with attaching a deleting line.

Moreover, because the referent extracting unit 1506 presumes that the referent is “XXX street”, the output control unit 1505 displays the Japanese words 2002 (“XXX street”) with attaching a double underline, which indicates that the words thereon is an estimation result based on the demonstrative words.

On the other hand, the translating unit 104 performs the translation processing on the interrupting speech similarly to the first embodiment, as a translation result, the speech output unit 106 outputs a Japanese sentence that means “The street is dangerous for you” in speech. Thus, the first speaker can clearly grasp an event that the listener interrupts during output of the translation result of the speech given by the first speaker his/herself, contents that has been communicated to the listener until the interruption point, and a corresponding part in the original speech to which “The street” in the interrupting speech given by the listener refers.

In the above example, the processing performed by the correspondence extracting unit 1507 is explained in the case where the translating unit 104 performs the translation processing by using the rule-based translation technology. In contrast, explained below is a case where the translating unit 104 performs the translation processing by using the example-sentence translation technology.

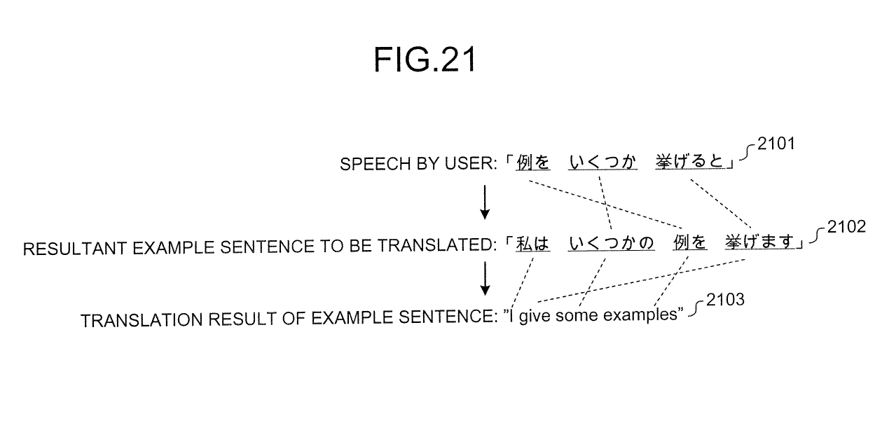

As shown in FIG. 21, when a user gives a Japanese speech 2101 that means “I give some examples”, and after speech recognition, the translating unit 104 searches a corresponding example sentence from a table (not shown) that stores therein example sentences, and then acquires a Japanese example sentence 2102.

The translating unit 104 further acquires a translation result 2103 corresponding to the Japanese example sentence 2102 from the table of example sentences, and outputs the translation result 2103 as a result of the example-sentence translation. The table is prepared in advance, so that correspondence between the translation result 2103 and the Japanese example sentence 2102 can be registered in advance. Correspondence between the Japanese speech 2101 given by the user and the Japanese example sentence 2102 can be established when the translating unit 104 compares the speech and example sentences. Consequently, the correspondence extracting unit 1507 can extract correspondence between the recognition result that is a sentence of the speech before translation and the translation result after translation within a possible range.

Thus, the translation apparatus 1500 can clearly states the interruption point interrupted in the speech, and the part in the original speech corresponding to the demonstrative word included in the interrupting speech, to present the contents of the original speech to the speaker. As a result, the speaker can grasp contents of the interrupting speech precisely, and can carry out a talk smoothly.

A translation apparatus 2200 according to a third embodiment controls the output procedure of a translation result of an original speech in accordance with an intention of an interrupting speech.

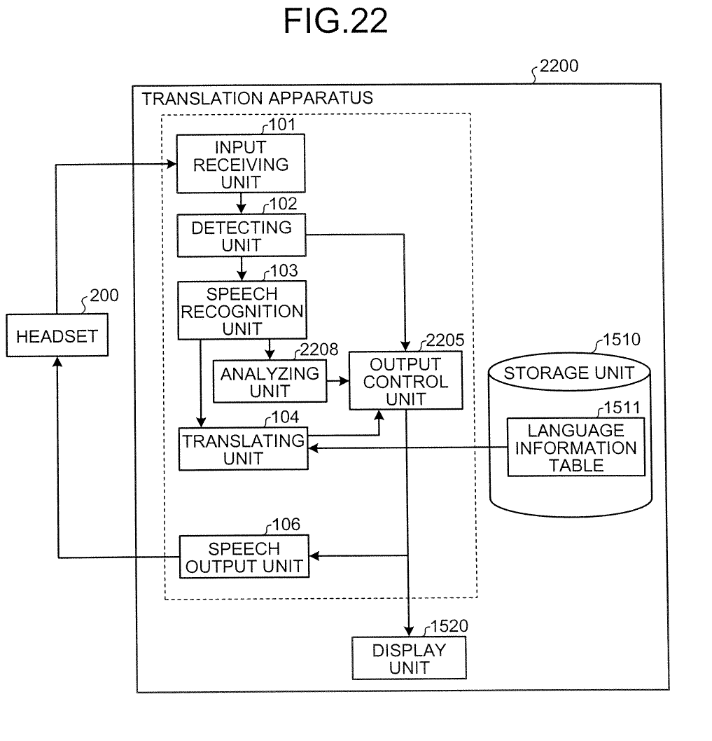

As shown in FIG. 22, the translation apparatus 2200 includes the storage unit 1510, the display unit 1520, the input receiving unit 101, the speech recognition unit 103, the detecting unit 102, the translating unit 104, an output control unit 2205, and an analyzing unit 2208.

In the third embodiment, the translation apparatus 2200 differs from the second embodiment in adding the analyzing unit 2208, and the output control unit 2205 functions differently from the second embodiment. Because the other units and functions of the translation apparatus 2200 are the same to the block diagram of the translation apparatus 1500 according to the second embodiment shown in FIG. 15, the same reference numerals are assigned to the same units, and explanations for them are omitted.

The analyzing unit 2208 analyzes an intention of a speech by performing the morphological analysis on a recognition result of a speech, and extracting a predetermined typical word that indicates the intention of the speech.

As a typical word, a word for a nod that means, for example, “uh-huh” and “I see”, or a word that means agreement such as “sure”, is registered in the storage unit 1510.

In addition to the functions of the output control unit 1505, the output control unit 2205 controls output of a translation result by referring to meaning of the interrupting speech analyzed by the analyzing unit 2208.

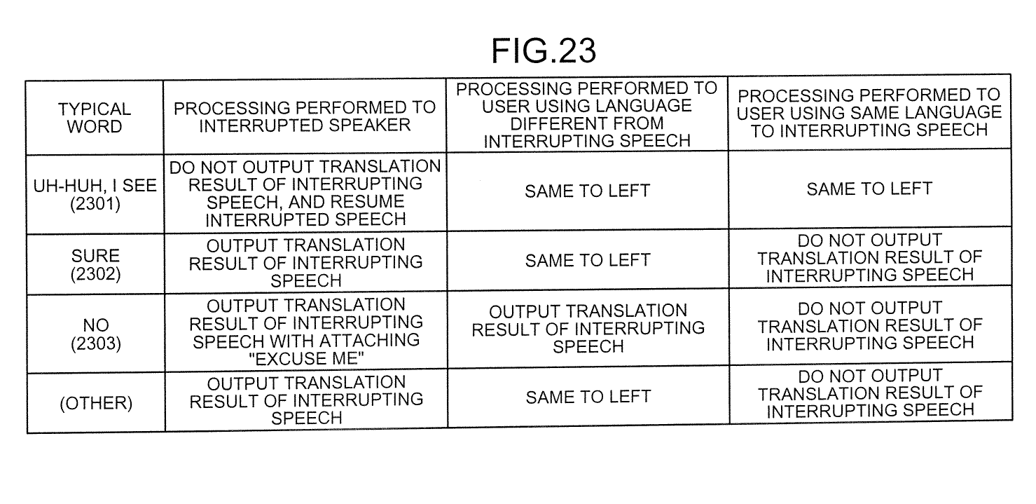

FIG. 23 is a schematic view for explaining rules when the output control unit 2205 decides on an output procedure by referring to meaning of the speech. In FIG. 23, users are defined in three definitions, namely, an interrupted user, a user who uses a different language from the interrupting speech, and a user who uses the same language to the interrupting speech; and examples of rules of output processing for respective users are associated in accordance with each of typical words.

Next, speech translation processing performed by the translation apparatus 2200 is explained below. The speech translation processing according to the second embodiment is almost similar to the speech translation processing according to the first and second embodiments as shown in FIG. 4, however, details of the output-procedure deciding process are different.

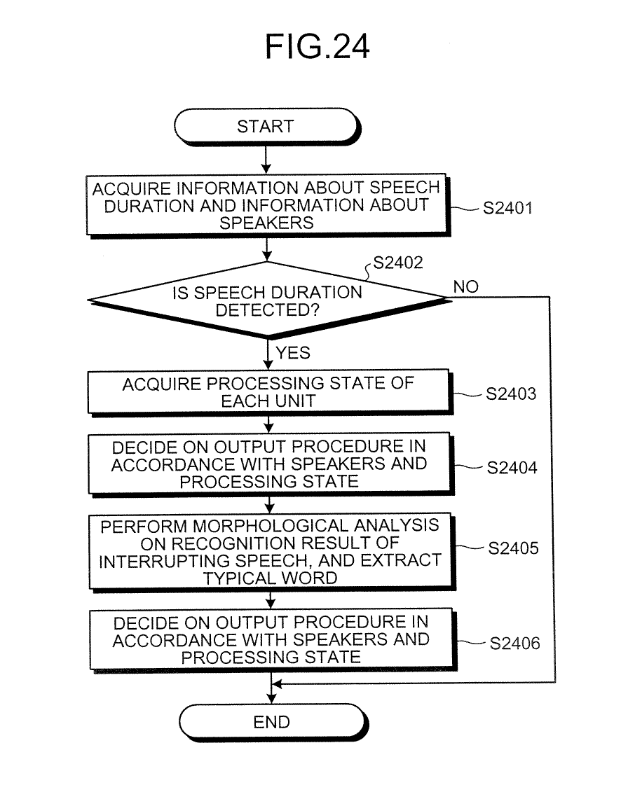

An output-procedure deciding process performed by the translation apparatus 2200 is explained below with reference to FIG. 24.

Deciding processing for output contents in accordance with users and a processing state from step S2401 to step S2404 is similar to the processing from step S601 to step S604 performed by the translation apparatus 100. In other words, the processing is performed on an interrupting speech under the rules shown in FIG. 3. In addition to this, according to the third embodiment, the following deciding processing for output contents in accordance with the users and an intention of the speech is performed. The translation apparatus 2200 can be configured to perform processing from step S2405 to step S2406, which is explained below, within step S2404 in inclusive manner.

At first, the analyzing unit 2208 performs the morphological analysis on a recognition result of the interrupting speech, and extracts a typical word (step S2405) Specifically, the analyzing unit 2208 extracts a word corresponding to one of preregistered typical words from a result of the morphological analysis on the recognition result of the interrupting speech. If any interrupting speech is not acquired in a frame, the following steps are not performed.

Next, the output control unit 2205 decides on an output procedure appropriate to the speakers and the typical word extracted by the analyzing unit 2208. Specifically, the output control unit 2205 decides on the output procedure under rules as shown in FIG. 23. Details of the deciding processing is explained below.

In the first case, where the typical word is a word 2301 that means a nod, such as “uh-huh” or “I see”, a translation result of the interrupting speech is not output, and output of an interrupted translation result is resumed. This can prevent the translation apparatus 2200 from outputting a translation result of a meaningless interrupting speech, which results in disruption against the talk. A method of resuming the interrupted speech can be achieved by a conventional barge-in technology.

In the second case, it is assumed that the typical word is a word 2302 that means agreement with the interrupted translation result, such as “sure”. In the second case, the translation result of the interrupting speech is not output to the user who uses the same language as the interrupting speaker. The reason for this is because the user can understand that the interrupting speech means agreement by listening to the interrupting speech itself.

A language corresponding to each of the user can be acquired by referring to information in the language information table 1511 present in the storage unit 1510.

On the other hand, the translation result of the interrupting speech is output to the user who uses a language other than the language used by the interrupting speaker, because it needs to be informed that the interrupting speech means agreement.

In the third case, it is assumed that the typical word is a word 2303 that means denial, such as “No”. In the third case, similarly to the second case for the word 2302, the translation result of the interrupting speech is not output to the user who uses the same language as the interrupting speaker.

The translation result of the interrupting speech is output to the user who uses a language other than the language used by the interrupting speaker, because it needs to be informed that the interrupting speech means denial. When outputting the translation result to the interrupted speaker, the translation result is attached with words that means “Excuse me”, and then output to the interrupted speaker, to avoid rudeness due to the interrupting speech. In contrast, such consideration is not required to the other users, so that the translation result of the input sentence is directly output.

These processing reduce a possibility that the interrupting speech gives a rude impression to the interrupted speaker, and makes the talk be carried out smoothly.

If a typical word does not belong to any category described above, the translation result of the interrupting speech is not output to the user who uses the same language as the interrupting speaker, and the translation result is output to the other users. Thus, these processing can omit redundant processing such that the translation result of interrupting speech is transferred to the user who uses the same language as the interrupting speaker.

Moreover, it can be configured to set information about typical words, prefixes, and processing corresponding to the typical words differently from language to language. Furthermore, it can be configures to refer to information about both the language of the interrupted speech and the language of the interrupting speech. As a result, for example, if an English user makes a nod in Japanese, the processing for the interrupting speech can be performed.

Thus, the translation apparatus 2200 can controls the output procedure for the translation result of the original speech in accordance with an intention of the interrupting speech. This can prevent the translation apparatus 2200 from outputting an unnecessary translation result of an interrupting speech, which may result in disruption against the talk.

In a speech translation system that processes a plurality of different languages, when an interrupting speech is made by an interrupting speaker who uses a language different from an interrupted speech, it is difficult to inform what the interrupting speech intends to mean by controlling only output to the interrupting speaker as provided by the conventional barge-in technology.

A method according to Japanese Patent No. 3513232 cannot deal with a situation particular to a speech translation system, for example, when another user makes an interrupting speech before the speech translation system outputs a translation result.

A translation apparatus 2500 according to a fourth embodiment controls output to match output contents of translation results to respective users, when three or more users use the translation apparatus 2500, a language of a first speaker (first user) differs from a language of a listener who gives an interrupting speech (second user), and another user (third user(s)) whose language differs from the languages of the two users uses the translation apparatus 2500.

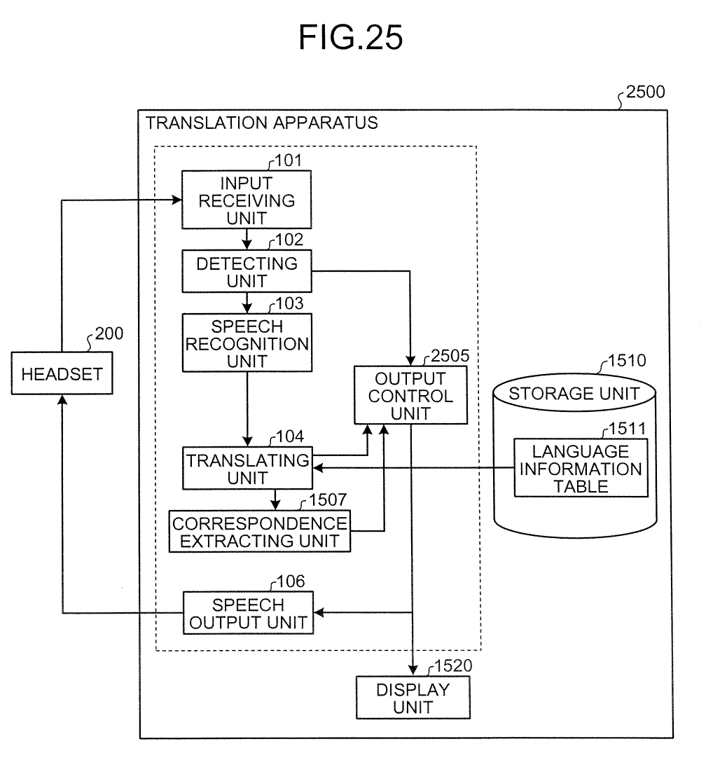

As shown in FIG. 25, the translation apparatus 2500 includes the storage unit 1510, the display unit 1520, the input receiving unit 101, the speech recognition unit 103, the detecting unit 102, the translating unit 104, an output control unit 2505, and the correspondence extracting unit 1507.

In the fourth embodiment, the translation apparatus 2500 differs from the second embodiment in omitting the referent extracting unit 1506, and the output control unit 2505 functions differently from the second embodiment. Because the other units and functions of the translation apparatus 2500 are the same to the block diagram of the translation apparatus 1500 according to the second embodiment shown in FIG. 15, the same reference numerals are assigned to the same units, and explanations for them are omitted.

Hereinafter, the language used by the first user is referred to as a first language, the language used by the second user is referred to as a second language, and a language different from the first language and the second language is referred to as a third language. When the first language and the second language are different, the translation apparatus 2500 controls to output, to the third user(s) who uses the third language, part of a translation result in the third language corresponding to part of a translation result of a first speech given by the first speaker that has been output to the second user in the second language until the interrupting speech is given. The output part of the translation result in the third language corresponds to the part output to the second user in the second language from among the translation result of the first speech given by the first user.

Next, speech translation processing performed by the translation apparatus 2500 is explained below. The speech translation processing according to the fourth embodiment is almost similar to the speech translation processing according to the first to third embodiments as shown in FIG. 4, however, details of the output-procedure deciding process are different.

Specifically, according to the fourth embodiment, in addition to the output-procedure deciding process through the process similar to the second embodiment, another output-procedure deciding process is performed for the third user(s) in the third language. In the following description, only the latter process is extracted to explain, however, in practice, the process similar to the second embodiment is also executed in parallel.

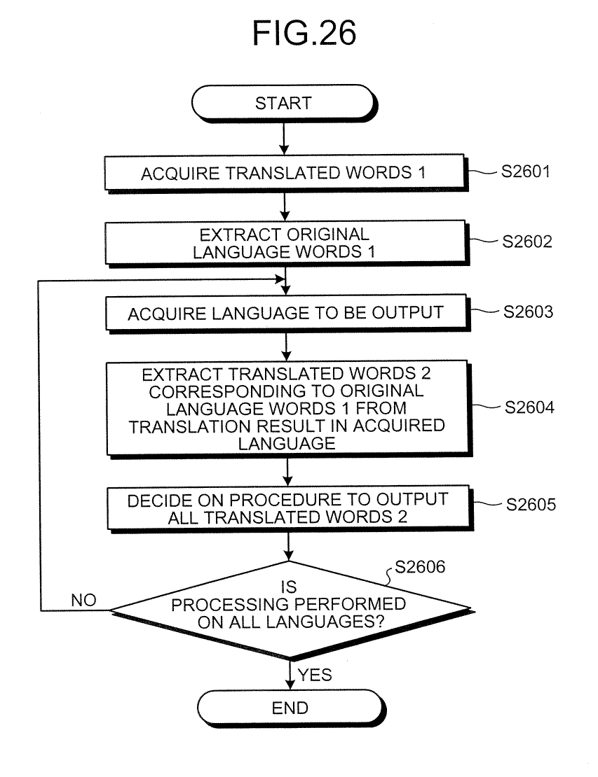

An output-procedure deciding process performed by the translation apparatus 2500 is explained below with reference to FIG. 26.

Hereinafter, from among the translation result output in the second language, part that has been output until the interrupting speech is detected is referred to as translated words 1. The output control unit 2505 acquires the translated words 1 at first (step S2601).

Hereinafter, corresponding part of a recognition result of the original speech corresponding to the acquired translated words 1 is referred to as original language words 1. The correspondence extracting unit 1507 then extracts the original language words 1 (step S2602). The corresponding part is extracted by referring to tree structures before and after conversion, similarly to the second embodiment.

Next, the output control unit 2505 acquires a language required to be output (step S2603). Specifically, the output control unit 2505 acquires languages for the users who use the translation apparatus 2500 from the language information table 1511, and acquires one language from the acquired languages.

Hereinafter, from among a translation result in the acquired language, part corresponding to the original language words 1 acquired at step S2602 is referred to as translated words 2. The correspondence extracting unit 1507 then extracts the translated words 2 (step S2604).

Next, the output control unit 2505 decides on an output-procedure to output the translation result at least until all of the acquired translated words 2 is output (step S2605). Accordingly, the part of the original language words corresponding to the part of the translation result in the second language that has been output until the interruption point can be output as a translation result in a language other than the second language.

The output control unit 2505 then determines whether all of the languages are processed (step S2606), if all of the languages have not been processed (No at step S2606), the output control unit 2505 acquires a next language, and repeats the processing (step S2603). If all of the languages are processed (Yes at step S2606), the output control unit 2505 terminates the output-procedure deciding process.

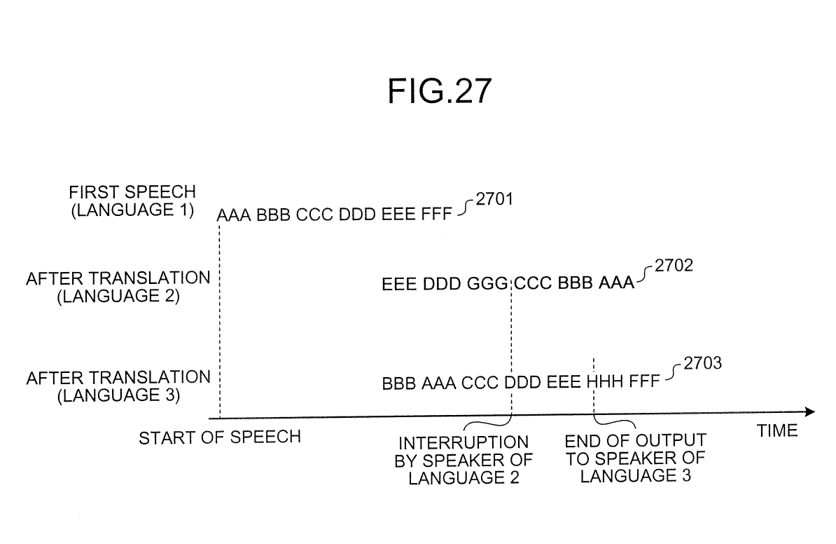

Next, a more specific example of information to be processed according to the fourth embodiment is explained with reference to FIG. 27.

In the example shown in FIG. 27, it is assumed that a first speaker gives a speech 2701 in a language 1. The speech 2701 is schematically expressed as resultant character strings into which the translating unit 104 divides an input sentence per predetermined unit by parsing the input sentence. For example, each of “AAA” and “BBB” is a divided unit.

The translation processing is performed on the speech 2701 in a language 2 and a language 3, and a translation result 2702 and a translation result 2703 are output respectively. The same character strings as those in divided units in the speech 2701 indicate respective corresponding parts in each of the translation results.

On the other hand, some parts that do not correspond between the original speech and the translation results can arise due to difference in grammatical rules of the languages, omission, or the like. In FIG. 27, character strings inconsistent with those in the divided units in the speech 2701 indicate the parts of the translation result that do not correspond to any part of the original speech. For example in FIG. 27, “GGG” in the translation result 2702 in the language 2 does not correspond to any part of the speech 2701.

FIG. 27 depicts that a speaker of the language 2 gives an interrupting speech at a time point until which part of the translation result 2702 in the language 2 has been output up to “GGG”. In this case, according to the fourth embodiment, the translation apparatus 2500 does not suspend output of the translation result 2703 in the language 3 just after interruption, however, can stop output processing after outputting part corresponding to the part already output in the language 2. A concrete example of such procedure is explained below.

To begin with, the output control unit 2505 acquires character strings “EEE DDD GGG” in the language 2, which have been output until the interrupting speech is detected (step S2601). Next, the correspondence extracting unit 1507 extracts corresponding part “DDD EEE” from the input sentence before translation (step S2602).

The correspondence extracting unit 1507 then extracts part from the translation result in the language 3 corresponding to extracted part “DDD EEE” (step S2604). In this example, corresponding divided units are all present in the language 3, so that “DDD EEE” are extracted.

Therefore, the output control unit 2505 decides on the output procedure to output the translation result in the language 3 up to “DDD EEE” (step S2605). In this example, when the interrupting speech is given, the translation result in the language 3 has been output only up to “BBB AAA CCC”, however, output of the translation result is continued until “DDD EEE” is output by monitoring processing in each frame.

As a result, output of the translation result in the language 3 is “BBB AAA CCC DDD EEE”. Thus, when an interrupting speech is input, the output control unit 2505 does not suppresses output of all translation results, the users share contents delivered by the interruption point, thereby avoiding discontinuance of context of the talk.

When outputting translation results to respective users of different three languages as described above, the translation apparatus 2500 can be configured to output the original speech and the interrupting speech in a clearly distinguishable manner by changing parameters for synthesizing voice. As a parameter for voice synthesis, any parameter can be used, such as gender of voice, characteristics of voice quality, average speed of speaking, average pitch of voice, and average sound volume.

For example, in the above example, the first speech (the language 1) and the interrupting speech (the language 2) are individually translated and two translation results are output to the third user. When outputting the translation result, parameters to which voice synthesis parameters for translation result are changed by predetermined extent. Accordingly, the users can clearly grasp presence of the interrupting speech.

Thus, when languages are different between the first speaker and the listener who makes the interrupting speech, the translation apparatus 2500 can match output contents of the translation result to be output to another user who uses a further different language to the contents for the other two. Consequently, disruption in the talk caused by discontinuance of context can be avoided.

Next, hardware configuration of the translation apparatus according to the first to fourth embodiments is explained.

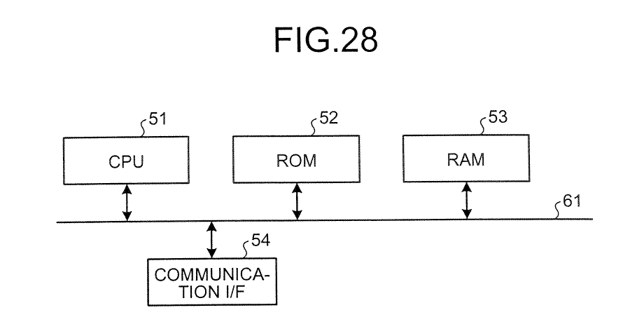

As shown in FIG. 28, the translation apparatus includes a control device, such as a central processing unit (CPU) 51, storage devices, such as a read-only memory (ROM) 52 and a random access memory (RAM), a communication interface (I/F) 54 that is connected to a network to communicate, and a bus 61 that connects each unit.

A machine translation program to be executed on the translation apparatus according to the first to fourth embodiments is provided by incorporating it into such as the ROM 52 in advance.

The machine translation program to be executed on the translation apparatus can be provided in a file in a installable format or in a executable format recorded onto a computer-readable recording medium, such as a compact disk read only memory (CD-ROM), a flexible disk (FD), a compact disk recordable (CD-R), and a digital versatile disk (DVD).

Furthermore, the machine translation program can be provided by being stored in a computer connected to a network such as the Internet, and downloaded by the translation apparatus via the network. Alternatively, the machine translation program can be provided or distributed via a network such as the Internet.

The machine translation program has module configuration that includes each unit described above (the input receiving unit, the speech recognition unit, the detecting unit, the translating unit, the output control unit, the referent extracting unit, the correspondence extracting unit, and the analyzing unit). As practical hardware, each of the units is loaded and created on the main memory as the CPU 51 reads out the machine translation program from the ROM 52, and executes the program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A machine translation apparatus comprising:
a receiving unit that receives an input of a plurality of speeches;
a detecting unit that detects a speaker of a speech from among the speeches;
a recognition unit that performs speech recognition on the speeches;
a translating unit that translates a recognition result to a translated sentence;
an output unit that outputs the translated sentence in speech; and
an output control unit that controls output of speech by referring to processing stages from receiving to outputting a first speech that is input first from among a plurality of the speeches, a speaker detected with respect to the first speech, and a speaker detected with respect to a second speech that is input after the first speech from among a plurality of the speeches.

2. The apparatus according to claim 1, wherein the output control unit controls not to output a translated sentence of the first speech, and to output a translated sentence of the second speech, when a speaker of the first speech differs from a speaker of the second speech.

3. The apparatus according to claim 1, wherein the output control unit controls to stop output of the translated sentence of the first speech, and to output a translated sentence of the second speech, when a speaker of the first speech differs from a speaker of the second speech, and when a translated sentence of the first speech is being output.

4. The apparatus according to claim 1, wherein the output control unit controls to stop output of the translated sentence of the first speech, and to output a translated sentence of the second speech, when a speaker of the first speech differs from a speaker of the second speech, when a translated sentence of the first speech is being output, and when a speech duration of the second speech is longer than a first threshold.

5. The apparatus according to claim 4, wherein the output control unit controls to stop output of the translated sentence of the first speech, and to output the translated sentence of the second speech, when a speaker of the first speech is same as a speaker of the second speech, when the translated sentence of the first speech is being output, and when a speech duration of the second speech is longer than a second threshold.

6. The apparatus according to claim 5, wherein the output control unit controls output of the translated sentence by using the second threshold that is smaller than the first threshold.

7. The apparatus according to claim 1, wherein the output control unit controls to output a translated sentence of the first speech and a translated sentence of the second speech, when a speaker of the first speech is same as a speaker of the second speech, and when the receiving unit completes receiving the first speech.

8. The apparatus according to claim 1, wherein the output control unit controls not to output a translated sentence of the first speech, and to output a translated sentence of the second speech, when a speaker of the first speech is same as a speaker of the second speech, and when the receiving unit completes a receiving of the first speech.

9. The apparatus according to claim 1, wherein the output control unit controls to replace part of the first speech corresponding to the second speech with the second speech, and to output a translated sentence of replaced first speech, when a speaker of the first speech is same as a speaker of the second speech, and when the receiving unit completes a receiving of the first speech.

10. The apparatus according to claim 1, further comprising:
a correspondence extracting unit that extracts correspondence between an original language word included in a recognition result of the speech and a translated word included in the translated sentence of the speech; and
a display unit that displays a recognition result of the first speech; wherein
the output control unit controls to acquire the translated word in the translated sentence of the first speech that is output before a start of the second speech, to acquire the original language word corresponding to acquired translated word based on the correspondence, and to output acquired original language word to the display unit in a different display manner from original language words other than the acquired original language word, when a speaker of the first speech differs from a speaker of the second speech.

11. The apparatus according to claim 1, further comprising:
a referent extracting unit that extracts a referent from the translated sentence of the first speech, when a recognition result of the second speech includes a demonstrative word that refers to the referent; and
a display unit that displays a recognition result of the first speech; wherein
the output control unit controls to output extracted referent to the display unit in a different display manner from words other than the referent.

12. The apparatus according to claim 1, further comprising a storage unit that stores a speaker and a language in associated manner, wherein the translating unit acquires a language corresponding to a speaker other than detected speaker from the storage unit, and translates a recognition result obtained by the recognition unit to a translated sentence in the acquired language.

13. The apparatus according to claim 1, further comprising an analyzing unit that parses semantic contents of the speech based on a recognition result of the speech, wherein the output control unit controls to output the translated sentence based on parsed semantic contents.

14. The apparatus according to claim 13, wherein the analyzing unit parses the semantic contents by extracting a typical word from the recognition result of the speech, the typical word indicating an intention of a speech and being defined in advance.

15. The apparatus according to claim 14, wherein:
the analyzing unit extracts the typical word that indicates an intention of a nod from a recognition result of the second speech, and analyzes the second speech to determine whether the second speech means the nod, and
the output control unit controls to output a translated sentence of the first speech, and not to output a translated sentence of the second speech, when the second speech means the nod.

16. The apparatus according to claim 1, further comprising a correspondence extracting unit that extracts correspondence between an original language word included in a recognition result of the speech and a translated word included in the translated sentence of the speech, wherein
the output control unit controls to acquire the translated word in the translated sentence in a second language output before a start of the second speech, to acquire the original language word corresponding to acquired translated word based on the correspondence, when a first language of the first speech differs from the second language of the second speech, and
the output control unit controls to acquire a translated word in the translated sentence in a third language corresponding to acquired original language word based on the correspondence, and to output acquired translated word in the translated sentence in a third language, when the translated sentence is output in the third language that is different from the first language and the second language.

17. The apparatus according to claim 1, wherein the output unit outputs the translated sentence by synthesizing a synthetic voice.

18. The apparatus according to claim 17, wherein the output control unit controls to output the translated sentence of the second speech in a third language that is different from a first language of the first speech and a second language of the second speech in a synthetic voice that is synthesized with properties different from properties of a synthetic voice used for outputting the translated sentence of the first speech in the third language, the properties of a synthetic voice including at least one of speed of speech, pitch of voice, volume of voice, and quality of voice, when the translated sentence is output in the third language.

19. A machine translation method comprising:
receiving an input of a plurality of speeches;
detecting a speaker of a speech from among the speeches;
performing speech recognition on the speeches;
translating a recognition result to a translated sentence;
outputting the translated sentence in speech; and
controlling output of speech by referring to processing stages from receiving to outputting a first speech that is input first from among a plurality of the speeches, a speaker detected with respect to the first speech, and a speaker detected with respect to a second speech that is input after the first speech from among a plurality of the speeches.

20. A computer program product having a computer readable medium including programmed instructions for machine translation, wherein the instructions, when executed by a computer, cause the computer to perform:
receiving an input of a plurality of speeches;
detecting a speaker of a speech from among the speeches;
performing speech recognition on the speeches;
translating a recognition result to a translated sentence;
outputting the translated sentence in speech; and
controlling output of speech by referring to processing stages from receiving to outputting a first speech that is input first from among a plurality of the speeches, a speaker detected with respect to the first speech, and a speaker detected with respect to a second speech that is input after the first speech from among a plurality of the speeches.
